(19) United States
(12) Patent Application Publication
(10) Pub. No.: US 2009/0047887 A1
(43) Pub. Date: Feb. 19, 2009

(54) Vacuum operated coin sorting assembly

(76) Inventor: Christopher Elabu, West Hempstead, NY (US)

Correspondence Address: DILWORTH & BARRESE, LLP, 333 EARLE OVINGTON BLVD., SUITE 702, UNIONDALE, NY, 11553, US

(21) Appl. No.: 11/891,725

(22) Filed: Aug. 13, 2007

(51) Int. Cl. G07D 3/00

(52) U.S. Cl. 453/3

(57) ABSTRACT

A coin sorting assembly is provided herein which includes a coin sorter having a sorter inlet for receiving coins; a vacuum source; and, a coin separator including a chamber having a coin inlet, a coin outlet for delivering coins to the sorter inlet, and a suction passageway connected to the vacuum source. The coin sorting assembly of the invention is advantageously used to collect and load scattered coins or heaps of coins into a coin sorter for sorting and counting.

### BACKGROUND

1. Field of the Invention

The present invention relates to a coin sorting assembly, and particularly to a coin sorter which employs suction to collect coins.

2. Background of the Art

Coin sorting apparatus are known in the art and are commonly used by banks and retail businesses which deal with cash. For example, U.S. Pat. Nos. 4,898,564, 4,963,118 and 5,040,657 disclose coin sorting and counting apparatus for high throughput processing of heterogeneous coin mixtures. U.S. Pat. No. 6,889,848 discloses a coin sorting and dispensing apparatus for automobiles.

A disadvantage of the conventional coin sorting apparatus is that the coins must be collected by hand and manually loaded into the coin sorter. This manual process is tedious and time consuming. What is needed is an apparatus for collecting coins which can be in heaps, or scattered across a surface, or lodged in corners which may be difficult to retrieve manually, and loading the coins into a coin sorter without the necessity of manually picking up and loading the coins.

### SUMMARY

A coin sorting assembly is provided herein which comprises (a) a coin sorter having a sorter inlet for receiving coins; (b) a vacuum source; and, (c) a coin separator including a chamber having a coin inlet, a coin outlet for delivering coins to the sorter inlet, and a suction passageway connected to the vacuum source.

The coin sorting assembly of the invention is advantageously used to collect and load scattered coins or heaps of coins into a coin sorter for sorting and counting.

### BRIEF DESCRIPTION OF THE DRAWINGS

Various embodiments are described below with reference to the drawings wherein:

FIG. 1 is a diagrammatic illustration of the coin sorter assembly of the invention;

FIG. 2 illustrates the coin separator section;

FIGS. 3 and 4 illustrate cross sectional views of the main passageway of the coin separator;

FIG. 5 illustrates an embodiment of the invention employing a one way flap valve; and

FIGS. 6A and 6B illustrate another embodiment of a one way valve.

### DETAILED DESCRIPTION OF PREFERRED EMBODIMENT(S)

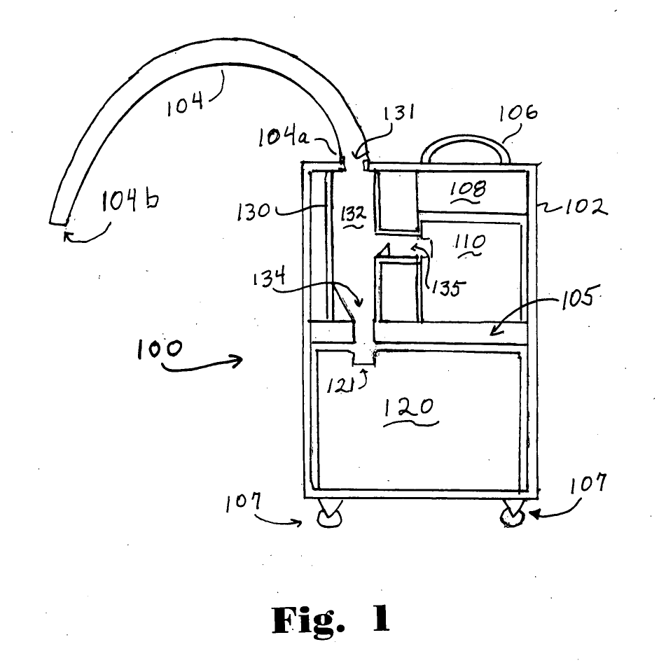

Referring now to FIG. 1, the coin sorter assembly 100 of the invention includes a housing 102 enclosing a coin sorter 120, a vacuum source 110, an electrical system 108, and a coin separator 130. Preferably, the coin sorter assembly 100 includes a handle 106, wheel supports 107, and an intake hose 104.

More particularly, housing 102 can be fabricated from any material of suitable strength such as, for example, metal (aluminum, steel, or other alloys) or engineering plastics (e.g., polycarbonates, acrylics, polyvinyl chloride, and the like).

The hose 104 can be of any convenient length (e.g., 1 to 3 feet). One end 104a is attached to the coin separator 130 or housing 102. The opposite end 104b is positioned in the vicinity of the coins to be taken into the coin sorter assembly 100 close enough for the coins to be drawn into the hose and carried by an air stream generated by suction. End 104a can be removably attachable by, for example, screw or bayonet type mounting.

The coin sorter 120 can be any apparatus capable of sorting and counting coins. Various coin sorters suitable for use in the invention are known and commercially available.

The suction is supplied by a blower 110 or other means of generating a vacuum. Blower apparatus 110 suitable for use in the invention are known and commercially available.

The electrical system 108 provides power to the blower 110 and/or coin sorter 120, and can be a battery (preferably a rechargeable battery) or an electrical connection to an external source of power, such as a conventional 110 volt AC outlet. An electrical cord (not shown) can be provided for connecting the electrical system 108 to the outlet or a source of power for charging a battery.

A shelf 105 of any suitable material can be employed to support the blower and coin separator 130.

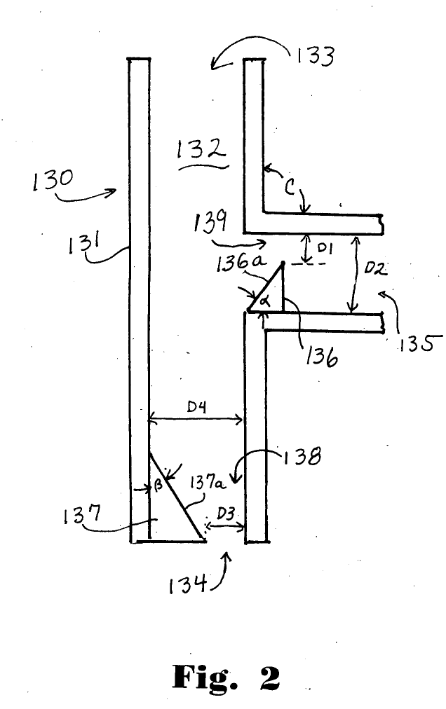

Referring now to FIG. 2, the coin sorter assembly requires a coin separator 130 to operate efficiently. The coin separator 130 allows the coins to be separated from the moving air stream in which they are carried. The air stream is diverted to the blower 110, and the coins are dropped by gravity into the inlet 121 of the coin sorter 120.

The coin separator 130 includes a body 131 having a generally T-shaped configuration.

Coins are introduced into the upper inlet opening 133 of the coin separator and fall through a chamber which provides a passageway 132 for the throughput of coins. Passageway 132 has a diameter preferably ranging from about 1 inch to about 2 inches. Suction port 135 extends transversely to the passageway 132 and is connected to the inlet of the blower 110. Suction port 135 has a diameter D2 which preferably ranges from about 1 inches to about 2 inches. Suction port 135 extends laterally from passageway 132 at angle C, where C is preferably 90°, but can range from about 70° to about 120°. A baffle 136 is disposed in the suction port 135 at the junction between the suction port 135 and the passageway 132. Baffle 136 includes a surface 136a which is inclined at angle α upwardly towards the direction of the blower 110. Angle α typically can range from about 30 degrees to about 80 degrees. The upper edge of the baffle 136 defines a passageway 139 through which air is drawn out of passageway 132 by suction. Passageway 139 has a diameter D1 which preferably ranges from about ½ inch to about 1 inch.

Referring to FIG. 2, it can be seen that coins may have a tendency to fall in the vicinity of passageway 139 because that is where the air flows. However, even if the coins fall into the opening of the suction port 135 they will strike inclined surface 136a and be deflected back into the passageway 132. The baffle 136 and angle α are configured and dimensioned to prevent coins from being drawn into suction passageway 135.

Baffle 137 is positioned at the bottom of passageway 132 in the vicinity of the coin outlet 134. Baffle 137 includes a surface 137a which is inclined downwardly at angle B. Angle β typically can range from about 25 degrees to about 85 degrees. The lower edge 137b of baffle 137 defines a passageway 138 through which the coins exit the coin separator 130 and are loaded into the coin sorter 120. Passageway 138 has a diameter D3 which preferably ranges from about ½ inch to about 1 inches. The baffle 137 and angle β are configured and dimensioned so as to offer resistance to air flowing upward from the coin sorter 120 while allowing coins to be deflected into passageway 138. Also, the deflected coins tend to be oriented parallel to the bottom edge 137b as they fall through passageway 138.

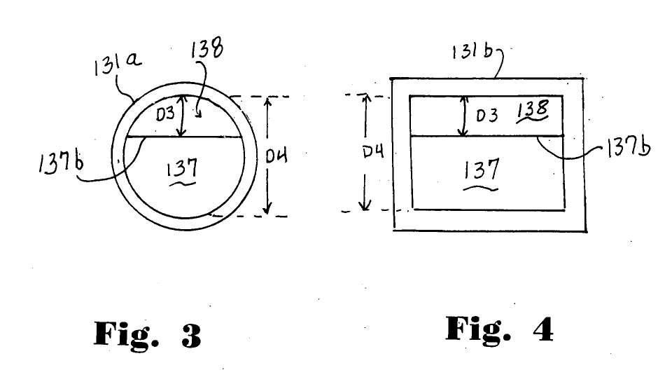

Referring now to FIGS. 3 and 4, the body 131 can be a cylindrical body 131a having a circular cross section as shown in FIG. 3, or a polygonal body 131b having a rectangular cross section. Other configurations of body 131 having oval, triangular, or other polygonal cross sections can be employed if desired.

Body 131 can be fabricated from any material of suitable strength such as aluminum, steel, or other metal, or, preferably, an engineering plastic such as polycarbonate, acrylic, polyvinylchloride and the like.

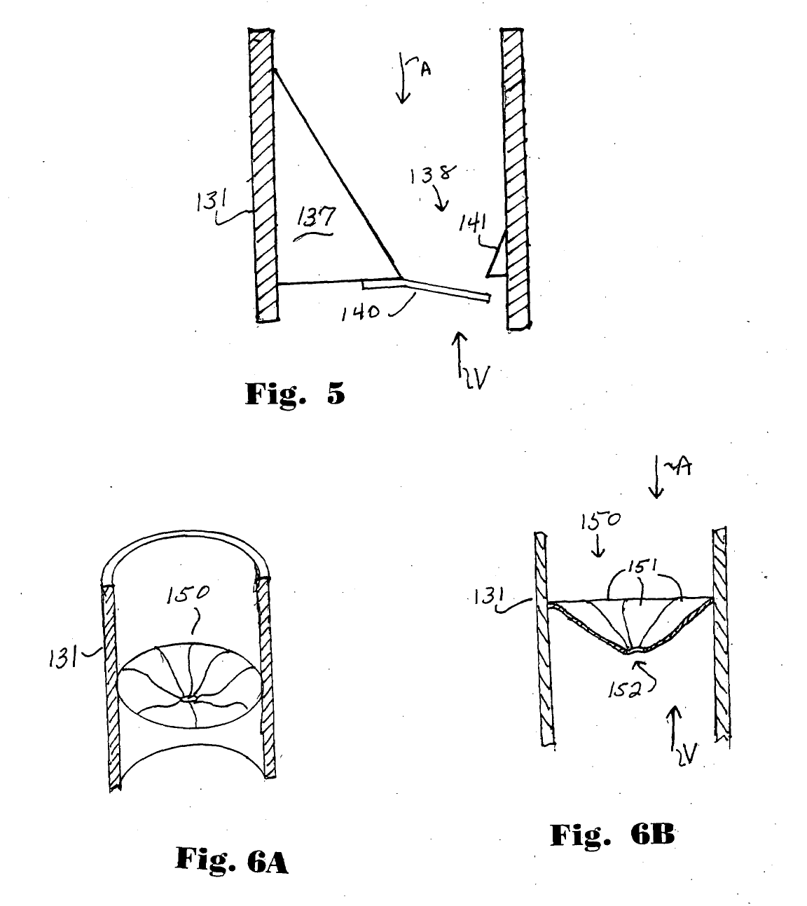

Referring now to FIG. 5, the invention can include a one-way valve such as a bendable flap valve 140 attached to baffle 137. A stop member 141 opposite the baffle 137 prevents the flap valve 140 from moving further upwards and provides for closure of the passageway 138. Flap valve 140 is preferably fabricated from a sheet of flexible material such as a thermoplastic polymeric film or rubber. The flap valve 140 can be fixed to the bottom of baffle 137 by adhesive or fastening members (screws, nails, etc.). During operation of the blower a suction force will tend to draw air from the coin sorter in the direction of arrow V. However, the air flow will tend to close the flap valve 140 thereby providing greater suction at the hose for collecting coins. When the coins are drawn into passageway 132 they will fall in the direction of arrow A under the force of gravity and the weight of the coins will tend to open the flap valve 140 to permit the coins to enter the coin sorter.

Referring now to FIGS. 6A and 6B, an alternative one-way valve 150 is shown which comprises a conical assembly of a plurality of overlapping, preferably individually movable, segments 151 which are arranged to provide an opening 152 of variable diameter. The segments 151 are preferably fabricated from a flexible material. During operation of the blower the suction created by the blower will tend to draw air in the direction of arrow V, which will bias the movement of the segments 151 upward to close or at least reduce the size of opening 152. However, the weight of coins falling through passageway 132 in the direction of arrow A will tend to move segments 151 downward, thereby expanding opening 152 to permit the coins to enter the coin sorter.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A coin sorting assembly which comprises:
a) a coin sorter having a sorter inlet for receiving coins;
b) a vacuum source; and,
c) a coin separator including a chamber having a coin inlet, a coin outlet for delivering coins to the sorter inlet, and a suction passageway connected to the vacuum source.

2. The coin sorting assembly of claim 1 wherein the suction passageway extends laterally from the chamber at a vertical angle of from about 70° to about 120°.

3. The coin sorting assembly of claim 1 wherein the suction passageway extends laterally from the chamber at an angle of about 90°.

4. The coin sorting assembly of claim 1 wherein the suction passageway includes a baffle positioned at the junction between the suction passageway and the chamber, wherein said baffle includes an inclined surface.

5. The coin sorting assembly of claim 4 wherein the inclined surface is oriented at an angle cc of from 30 degrees to about 60 degrees.

6. The coin sorting assembly of claim 5 wherein the baffle defines a restricted passageway through which air is drawn out by suction from the chamber.

7. The coin sorting assembly of claim 6 wherein the restricted passageway has diameter ranging from ½ inch to about 1 inch.

8. The coin sorting assembly of claim 1 further including a hose attached to the coin inlet.

9. The coin sorting assembly of claim 1 wherein the hose is removably attached to the coin inlet by screw or bayonet type mounting.

10. The coin sorting assembly of claim 1 wherein the chamber comprises a tubular passageway positioned in a substantially vertical orientation.

11. The coin sorting assembly of claim 1 further comprising a one-way valve positioned in the vicinity of the coin outlet.

12. The coin sorting assembly of claim 11 wherein the one-way valve comprises a flap valve.

13. The coin sorting assembly of claim 12 wherein the flap valve comprises a sheet of flexible polymeric material.

14. The coin sorting assembly of claim 11 wherein the one-way valve comprises a conical assembly of overlapping individually movable segments arranged to provide an opening of variable diameter.

15. The coin sorting assembly of claim 1 further including a blower for providing the vacuum.

16. The coin sorting assembly of claim 1 further including means for providing electrical power.

17. The coin sorting assembly of claim 16 wherein the means for providing electrical power comprises a rechargeable battery.

18. The coin sorting assembly of claim 16 wherein the means for providing electrical power comprises an electrical cord and plug adapted for connection to a standard 110 volt electrical outlet.

19. The coin sorting assembly of claim 1 further comprising a housing for enclosing said coin sorter, vacuum source and coin separator.

20. The coin sorting assembly of claim 19 wherein the housing is portable and includes a handle.
